(19) United States
(12) Patent Application Publication
(10) Pub. No.: US 2004/0232801 A1
(43) Pub. Date: Nov. 25, 2004

(54) Electrostatic high voltage generator

(76) Inventor: Lance F. Jerale, Maintowoc, WI (US)

Correspondence Address: Lance F. Jerale, 627 North 9th Street, Manitowoc, WI, 54220, US

(21) Appl. No.: 10/443,171

(22) Filed: May 23, 2003

(51) Int. Cl. H02N 1/00

(52) U.S. Cl. 310/309

(57) ABSTRACT

The present induction type electrostatic generator includes an insulating cylinder containing insulating members in the form of beads or grains. The cylinder is rotated about its horizontal axis so that the inner surface of the cylinder is triboelectrically charged by the insulating members as they slide, roll, or bounce over the inner surface of the cylinder as it is rotated. An equilibrium of electrostatic charge is soon established in which the insulating members acquire one polarity of charge, while the inside surface of the rotating cylinder acquires the opposite polarity of charge. The net charge of the rotating cylinder and its contents is zero, but the distribution of charges is not uniform. The insulating members remain near the bottom of the cylinder as it rotates, being pulled in the direction of rotation by friction and electrostatic forces of attraction while gravity holds them down toward the lowest point of the cylinder. The electrostatic potential of a given area of the cylindrical surface changes dramatically as the cylinder rotates. The cyclic swing of the electrostatic potential of the outer surface creates an opportunity to apply counter-charges by induction from a grounded brush or flexible conducting blade onto the outer surface of the cylinder where it is in close proximity to the charged insulating members. Then, as that portion of the cylinder rotates upward, the voltage of the induced counter-charges increases substantially as they separate from the charged insulating members near the bottom of the rotating cylinder.

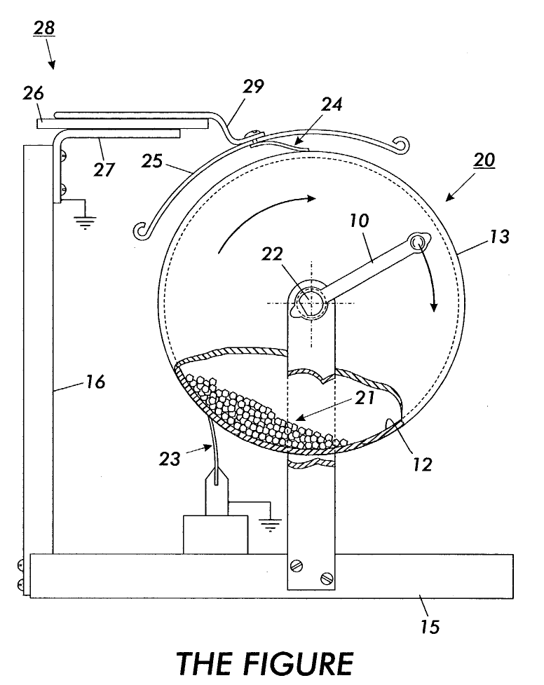

### BACKGROUND OF THE INVENTION

1. Field of the Invention

This invention relates generally to electrostatic generators, and in particular, to an improved generator in which charges are generated by triboelectric charging of a loose aggregate of granular material maintained in sliding contact with a relatively small area on the inside surface of a thin-walled insulating cylinder, where they induce counter charges from an external source onto the outside surface of the insulating cylinder.

2. Description of Related Art

Ever since the invention of the first electrostatic generator by Otto von Guericke around 1660, many forms of electrostatic generators have been conceived and built. Most noteworthy is the Van de Graaff “Faraday Cage” generator. Another is Professor A.D. Moore's “Dirod” generator, described in his book, Electrostatics (Doubleday: Garden City, N.J., 1968).

The Van de Graaff generator, described in Physics, by Henry Margenau (McGraw-Hill: 1949), is capable of generating electrostatic potentials of millions of volts. A moving belt is charged by corona ionization of air at the tips of nearby high-voltage conducting needles, which are pointed toward the belt. The charged belt is then driven into the inside of a conducting sphere, or “Faraday Cage”, where its charges are transferred to the surrounding sphere, progressively raising it to very high potentials.

The Moore generator consists of a large number of conducting rods mounted in parallel, and spaced uniformly at a fixed radius along an insulating circular disk, all rods being perpendicular to the disk.

The problems with induction generators of this type include the complexity of parts, such as, in the Van de Graaff generator, pulleys driving a long insulating belt that carries electric charges into the Faraday cage. Also, long insulating supports are needed for the Faraday cage to electrically isolate it from any grounded or low voltage conductor. In the case of the Dirod generator, a large number of conducting rods are needed to receive induced charges near one conducting plate, and then to deliver those induced charges from each of the rods through fragile conducting brushes to a second plate. Hence, there is a need for an improved induction generator.

### SUMMARY OF THE INVENTION

Accordingly, the instant invention provides a very affordable electrostatic generator that is simple to build and understand, rugged, and easily transported for demonstrations, and easily cleaned and dried for operation in environments of high relative humidity. Also, it is so compact and robust that it can be held in the operator's lap, powered by a small hand crank, so there is no need for connection to an electrical power source. Therefore it is ideal for use in classrooms or at home as a very efficient teaching tool. The invention includes a closed rotatable insulating cylinder having frictional charging members positioned within the insulating cylinder. A first charge transfer member is mounted in close proximity to an outside surface of the insulating cylinder directly opposite an inner surface of the insulating cylinder where the frictional charging members make sliding contact with the inside surface of the insulating cylinder. In order to deliver charges to the high voltage terminal a second charge transfer member is mounted to remove high voltage charges from the outside surface of the insulating cylinder at a point approximately diametrically opposite the first charge transfer member.

These and other features and advantages of the invention are described in, or will be apparent from, the following detailed description of the exemplary embodiments.

### BRIEF DESCRIPTION OF THE DRAWING

The foregoing and other features of the instant invention will be apparent and easily understood from a further reading of the specification and claims, and by reference to the accompanying drawing, in which like reference numerals refer to like elements, and wherein:

The FIGURE is a schematic elevational view of an electrostatic high voltage generator in accordance with the present invention.

### DETAILED DESCRIPTION OF THE INVENTION

While the present invention will be described in connection with a preferred 10 embodiment thereof, it will be understood that it is not intended to limit the invention to that embodiment. On the contrary, it is intended to cover all alternatives, modifications, and equivalents as may be included within the spirit and scope of the invention as defined by the appended claims.

Referring now to The FIGURE, the electrostatic high voltage generator of the instant invention consists of a thin-walled insulating dielectric cylinder 20, closed and supported by a disk at each end, and into which a loose aggregate of coarse powder, grains, or beads 21 is inserted. The quantity of the grains or beads 21 should be adequate to fill an arc of about 30 to 60 degrees along the lower region of the inner surface 12 of the cylinder 20 over which they will roll, bounce, or slide when the cylinder is rotated either manually by handle 10, or by a motor (not shown), on its horizontal axis 22. The beads should have a triboelectric relationship with the cylinder such that, initially, substantial charge exchange takes place when the beads cascade along the inner surface 12 of the rotating cylinder under the force of gravity. The charge exchange reaches equilibrium after many cycles in which charges of one polarity reside on the beads 21 and charges of the opposite polarity reside on the inner surface 12 of the rotating cylinder 20.

While the quantity of positive and negative charges will be equal, since neither the beads 21, nor the inside surface 12 of cylinder 20 have any outside source of charging, the charges will not be uniformly distributed.

Assume the triboelectric charge exchange leaves the beads 21 positively charged and the inside surface 12 of the cylinder 20 negatively charged. In the region where the beads lie, the charges on the beads produce considerable positive voltage. That voltage induces negative counter-charges from the grounded conducting brush or flexible blade 23 mounted in close proximity with outside surface 13 of the cylinder 20 adjacent to the beads 21. Many of those negative charges transfer from brush or blade 23 to outside surface 13 of rotating cylinder 20, and produce negative voltage relative to the beads that grows very substantially as the cylinder rotates, carrying those induced negative charges further from the positively charged beads. Near the top of the cylinder, those high voltage charges are removed from the outer surface 13 of cylinder 20 by a similar conducting brush or blade 24 which is connected to the high voltage terminal 25 which, in turn, is connected to high voltage capacitor 28. High voltage capacitor 28 includes a high dielectric strength insulating layer 26 separating capacitor plates 27 and 29. The support 16 has mounted thereon lower plate 27 of high voltage capacitor 28. High voltage terminal 25 can be used for typical demonstrations of electrostatic phenomena, such as, corona winds, pithball oscillations, glow lamp discharges, smoke precipitation, electrostatic spark discharges, and many entertaining and educational demonstrations of commercially practical applications.

In summary, the advantages of the electrostatic generator of the present invention are its elegant simplicity, easily understood principles of operation, and ease of drying and cleaning for more reliable operation in conditions of high relative humidity which often compromise the proper functioning of electrostatic generators. The improved electrostatic generator of the present invention is rugged, compact, simple, and inexpensive. Also, it is easy for students to understand its principles of operation, making it a highly valuable teaching tool.

While the invention has been described in conjunction with the specific embodiments outlined above, it is evident that many alternatives, modifications and variations will be apparent to those skilled in the art. Accordingly, the preferred embodiments of the invention as set forth above are intended to be illustrative and not limiting. Various changes may be made without departing from the spirit and scope of the invention as defined herein.

What is claimed is:

1. An electrostatic generator, comprising:
a rotatable insulating cylinder;
frictional charging members positioned within said insulating cylinder;
a first charge transfer member mounted in close proximity with an outside surface of said insulating cylinder directly opposite an inner surface thereof, and wherein said frictional charging members make sliding contact with said insulating cylinder; and
a second charge transfer member mounted to remove high voltage charges from said outside surface of said insulating cylinder approximately diametrically opposite said first charge transfer member for delivering charges to a high voltage terminal.

2. The electrostatic generator of claim 1, wherein the axis of rotation of said insulating cylinder is coincident with the axis of said insulating cylinder.

3. The electrostatic generator of claim 2, wherein the axis of rotation of said insulating cylinder is horizontal.

4. The electrostatic generator of claim 3, wherein said frictional charging members include material supported in sliding and rolling contact with said inner surface of said insulating cylinder and distributed in the bottom of said cylinder.

5. The electrostatic generator of claim 4, wherein said frictional charging material includes coarse powder.

6. The electrostatic generator of claim 4, wherein said frictional charging material includes grains.

7. The electrostatic generator of claim 4, wherein said frictional charging material includes beads.

8. The electrostatic generator of claim 1, wherein said first charge transfer member is a conducting brush or flexible blade, supported in close proximity with said outer surface of said insulating cylinder parallel to its axis of rotation.

9. The electrostatic generator of claim 1, wherein said first charge transfer member is made of any suitable fabric, wire, or other conductive substance supported in close proximity with said outer surface of said insulating cylinder parallel to its axis of rotation.

10. The electrostatic generator of claim 1, wherein said frictional charging members induce counter-charges which are separated from said frictional charging members by an insulating film of sufficient dielectric strength to prevent arcing between said inducing charges and said induced counter-charges.

11. A triboelelectric charging, induction-type electrostatic generator:
a rotatable insulating cylinder mounted on a horizontal axis of rotation;
frictional charging members supported in sliding contact in relation with an inside surface of said insulating cylinder; and
charge transfer members, said charge transfer members including a pair of conductive brushes or flexible blades mounted in close proximity with said insulating cylinder in order to enable charge transfer to an outside surface of said insulating cylinder.

12. The triboelectric charging, induction-type electrostatic generator of claim 11, wherein said frictional charging members includes coarse powder.

13. The triboelectic charging, induction-type electrostatic generator of claim 11, wherein said frictional charging members includes grains.

14. The triboelectric charging, induction-type electrostatic generator of claim 11, wherein said frictional charging members includes beads.
